(19) United States
(12) Patent Application Publication
(10) Pub. No.: US 2015/0381955 A1
(43) Pub. Date: Dec. 31, 2015

(54) IMAGE PROJECTION SYSTEM

(71) Applicant: Atsushi TAKAGI, Kanagawa (JP)

(72) Inventor: Atsushi TAKAGI, Kanagawa (JP)

(21) Appl. No.: 14/729,210

(22) Filed: Jun. 3, 2015

(30) Foreign Application Priority Data
Jun. 30, 2014 (JP) 2014-134788

(51) Int. Cl. H04N 9/31; H04N 13/02

(52) U.S. Cl. CPC H04N 9/3185; H04N 13/0203

(57) ABSTRACT

An image projection system includes an image projection means to project an image on a projection surface to form a reference image thereon; an capturing means to image the reference image to obtain an capturing result; a projection conditions correction means to correct projection conditions of the image projection mean on the basis of the capturing result; an intervening member detection means to detect an intervening member lying between the image projection means and the projection surface to obtain a detection result; and an capturing result correction means to correct the capturing result on the basis of the detection result. The projection conditions correction means corrects the projection conditions on the basis of the capturing result corrected by the capturing result correction means when the intervening member is detected by the intervening member detection means.

### CROSS-REFERENCE TO RELATED APPLICATIONS

This patent application is based on and claims priority pursuant to 35 U.S.C. §119 to Japanese Patent Application No. 2014-134788, filed on Jun. 30, 2014, in the Japan Patent Office, the entire disclosure of which is hereby incorporated by reference herein.

### BACKGROUND

1. Technical Field

The present invention relates to an image projection system correcting projection conditions such as s position, a size and a keystone distortion correction amount of a projection image in an image projector on the basis of the result of capturing a reference image projected by the image projector.

2. Description of the Related Art

Conventionally, as the image projection system, an image projection system disclosed in Japanese Patent No. JP-4553046-B2 (Japanese published unexamined application No. JP-2009-219102-A) is known. The image projection system projects a specified reference image onto a projection surface such as screens from a projector. Then, the reference image on the projection surface is captured by a capturing means such as CCD cameras to obtain image information. Based on the image information, a position of the reference image, a size thereof and a keystone distortion correction amount thereof on the projection surface are acquired. Base on the acquired results, the position of the reference image, the size thereof and the keystone distortion correction amount thereof on the projection surface are corrected. The image can be projected onto a desired position in a desired size without keystone distortion with the correction.

However, when the reference image projected onto the projection surface is captured by the capturing means, an intervening member such as spectators lies between the projection surface and the capturing means and a part of the reference image is occasionally projected on the surface of the intervening member before the projection surface. The part of the image projected on the intervening member is possibly projected on a position different from an appropriate position or in a size different from an appropriate size due to a difference of projection distance between the projection surface and the intervening member. When the intervening member has the surface having a complicated dimensional form (not flat), the part of the image projected on the intervening member possibly has a form different from an appropriate form. Nevertheless, when correction amounts of projection conditions such as projection position, size and keystone distortion correction amount of a reference image is determined on the basis of the position, size and form of the part of the image, the correction amounts may be out of appropriate amounts, resulting in poor quality of the projection image.

### SUMMARY

Accordingly, one object of the present invention is to provide an image projection system capable of preventing a projection image from deteriorating when projection conditions are corrected while an intervening member is provided between a projection surface and a capturing means.

The object of the present invention, either individually or collectively, have been satisfied by the discovery of an image projection system, including an image projection means to project an image on a projection surface to form a reference image thereon; an capturing means to image the reference image to obtain an capturing result; a projection conditions correction means to correct projection conditions of the image projection mean on the basis of the capturing result; an intervening member detection means to detect an intervening member lying between the image projection means and the projection surface to obtain a detection result; and an capturing result correction means to correct the capturing result on the basis of the detection result, wherein the projection conditions correction means corrects the projection conditions on the basis of the capturing result corrected by the capturing result correction means when the intervening member is detected by the intervening member detection means.

The object, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic plain view illustrating a main configuration of an embodiment of the image projection system of the present invention;

FIG. 2 is a front view illustrating three light spots projected on a screen by three projectors of the image projection system respectively;

FIG. 3 is a front view illustrating a reference static image projected on a screen by a first projector of the image projection system before projection conditions are corrected;

FIG. 4 is a front view illustrating a reference static image projected on a screen by the first projector after projection conditions are corrected;

FIG. 5 is a front view illustrating a reference static image projected on a screen by a second projector of the image projection system before projection conditions are corrected;

FIG. 6 is a front view illustrating a reference static image projected on a screen by the second projector after projection conditions are corrected;

FIG. 7 is a front view illustrating a reference static image projected on a screen by a third projector of the image projection system before projection conditions are corrected;

FIG. 8 is a front view illustrating a reference static image projected on a screen by the third projector after projection conditions are corrected;

FIG. 9 is a schematic plain view illustrating the image projection system with a spectator as an intervening member;

FIG. 10 is a schematic plain view for explaining TOF method which is one of methods of measuring distances using a 3D camera of the image projection system;

FIG. 11 is a front view illustrating a reference static image projected on a screen by the second projector in correction process of projection conditions;

FIG. 12 is a front view illustrating the reference static image in FIG. 11 after corrected;

FIG. 13 is a flowchart showing correction process of projection conditions executed by a controller in the image projection system;

FIG. 14 is a schematic plain view illustrating a main configuration of another embodiment of the image projection system of the present invention; and

FIG. 15 is a front view illustrating a synthetic image formed by a controller of the image projection system in FIG. 14

### DETAILED DESCRIPTION

The present invention provides an image projection system capable of preventing a projection image from deteriorating when projection conditions are corrected while an intervening member is provided between a projection surface and a capturing means. Exemplary embodiments of the present invention are described in detail below with reference to accompanying drawings. In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

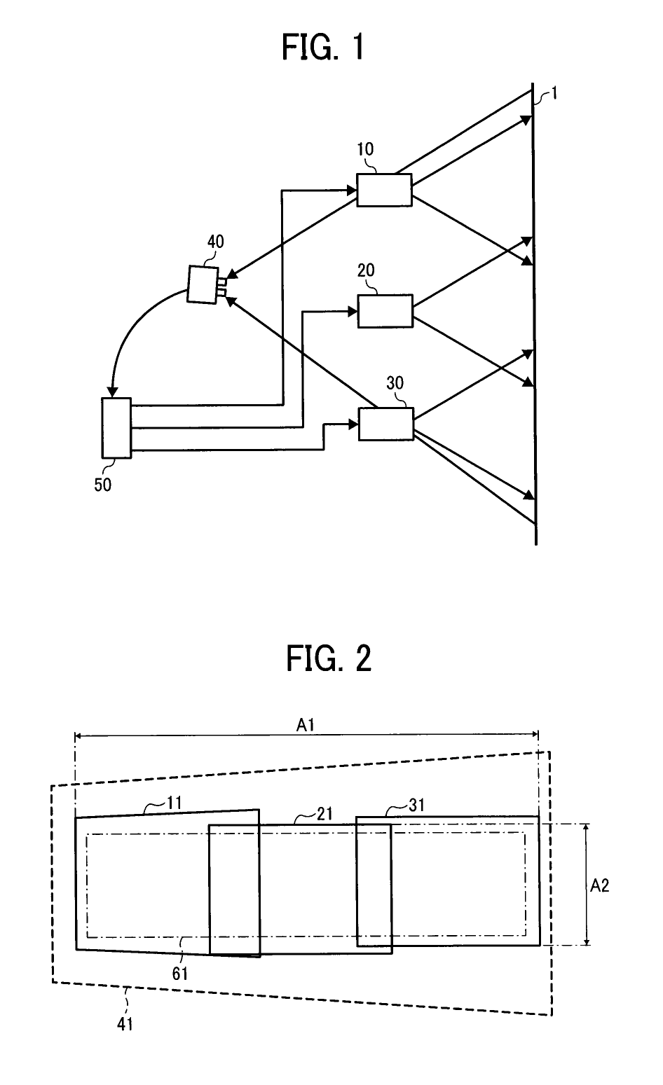

FIG. 1 is a schematic plain view illustrating a main configuration of an embodiment of the image projection system of the present invention. The image projection system includes a first projector 10, a second projector 20 and a third projector 30 projecting images with known technologies. The number of the projectors is not limited to three, and may be one, two or four or more.

The image projection system further includes a 3D camera 40 as a capturing means and a controller 50 such as PCs besides the three projectors. The controller 50 includes a CPU (Central processing Unit), a ROM memorizing a control program (Read-Only Memory), a RAM (Random Access Memory) temporarily memorizing data, a nonvolatile flash memory, a hard disc, etc. The ROM memorizes image information of a reference static image as a reference image (hereinafter referred to as reference static image data) for the first projector 10, the second projector 20 and the third projector 30 to individually project. Image information of a moving image (hereinafter referred to as moving image data) projected on the surface of a screen 1 is memorized in the hard disc as a memory. Based on the moving image data, image information of three partial moving images (partial images) reproducing only areas different from each other in all areas of the moving image (hereinafter referred to as partial moving image data) is produced. First partial moving image data in the three partial moving image data is output to the first projector 10. Second partial moving image data therein is output to the second projector 20. Third partial moving image data therein is output to the third projector 30.

The first projector 10 having received the first partial moving image data projects the first moving image reproducing only left side end in all areas of the original moving image onto left side of the surface of the screen 1. The second projector 20 having received the second partial moving image data projects the second moving image reproducing only a the center in all areas of the original moving image onto the center of the surface of the screen 1. The third projector 30 having received the third partial moving image data projects the third moving image reproducing only right side end in all areas of the original moving image onto right side of the surface of the screen 1.

Right side end of the first partial moving image projected by the first projector 10 and left side end of the second partial moving image projected by the second projector 20 are overlapped on the surface of the screen 1. Since the right side end and left side end are the same image, even the overlapped area reproduces the same moving image as the original moving image. An area where right side end of the second partial moving image projected by the second projector 20 and left side end of the third partial moving image projected by the third projector 30 are overlapped reproduces the same moving image as the original moving image as well. Hereinafter, the area where the partial moving images are overlapped is referred to as an overlapping area.

It is difficult to finely adjust positions of the first partial moving image and the second partial moving image such that the right end of the first partial moving image matches with he left end of the second partial moving image. When they do not match with each other, a highly noticeable blank is formed between the partial moving images and the moving image may noticeably deteriorate in quality. Further, a similar blank formed between the second partial moving image and the third moving image may noticeably deteriorate the moving image quality. Therefore, each of the moving images has an overlapping area they reproduce the same partial moving images each other.

The image projection system uses a multi-projection method individually projecting partial moving images onto different areas on the screen surface and combining the partial moving images to reproduce the original moving image. The image projection system of the present invention may use a method of using only one projector instead of the multi-projection method.

First, the three projectors need to be located in proper positions to project the original moving image on the screen surface by the multi-projection method. The locating is made by a user. After the locating is finished, an initial setting processing and projection condition correction processing mentioned later are needed. These are made by the controller 50. The 3D camera 40 outputs a capturing result of an image such as a moving image projected on the screen 1 to the controller 50 as image information.

Receiving an order of starting the initial setting from a user, the controller 50 starts the initial setting processing. Then, the controller 50 makes each of the three projectors project only light which does not include light to the screen 1. Thus, as shown in FIG. 2, the first projector 10 projects a first light spot 11, the second projector 20 projects a second light spot 21, and the third projector 30 projects a third light spot 31 onto the screen 1. The user previously sets the 3D camera 40 so as to have a capturing area 41 including the three light spots on the screen surface. An unillustrated periphery of the screen 1 is located outside of the capturing area 41.

In FIG. 2, the first light spot 11 has the shape of a trapezoid because of having comparatively a large trapezoidal distortion. As shown in FIG. 2, the right end of the first light spot 11 has a height considerably larger than that of the left end. This is because the first projector 10 is located aslant a bit along horizontal direction relative to a vertical direction of the screen surface. In this case, a trapezoidal distortion correction is needed to project a rectangular image in the trapezoidal first light spot 11. The second light spot 21 and the third light spot 31 do not have outstanding distortions. The trapezoidal distortion correction is mentioned later.

Next, the controller 50 orders the 3D camera 40 to image the first light spot 11, the second light spot 21 and the third light spot 31 on the screen surface, and receives image information obtained by the capturing from the 3D camera 40. Based on the image information, a projection wide area A1 from the left end of the first light spot 11 to the right end of the third light spot 31 in a crosswise direction of the screen surface, and a minimum projection vertical area A2 in a perpendicular direction thereof are specified. Further, an area surrounded by the projection wide area A1 and the minimum projection vertical area A2 is set as an image projection area 61 to finish the initial setting processing.

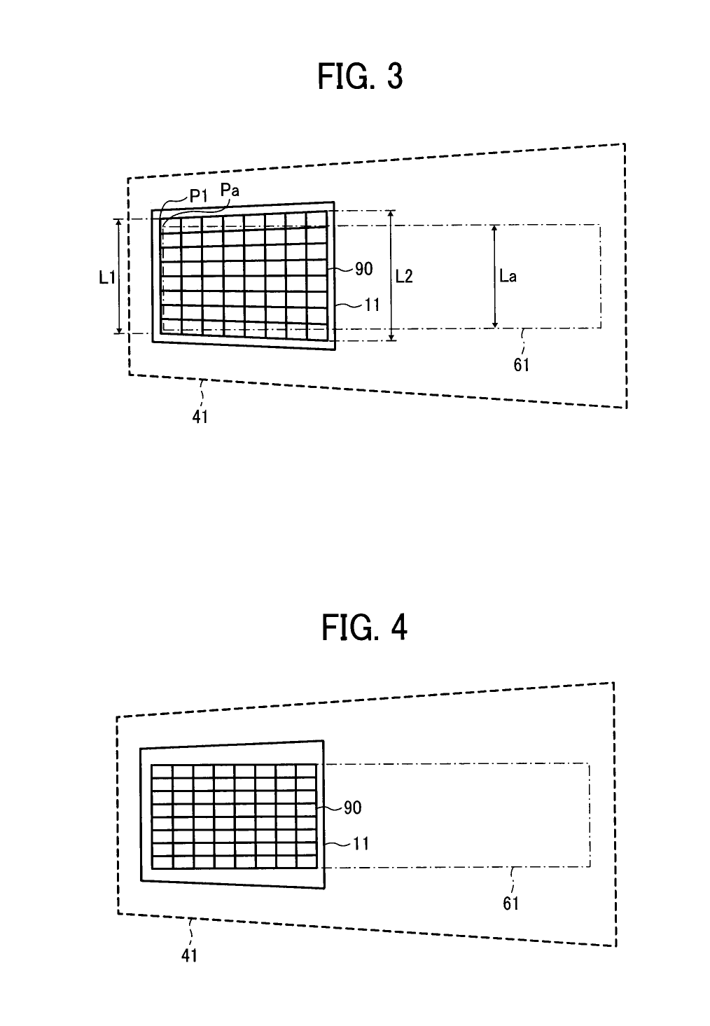

Next, the controller 50 executes a projection condition correction processing so as to project a projection moving image based on moving image data memorized in a hard disc thereof on the screen surface in the same position and the same size as those of the image projection area 61. First, as shown in FIG. 3, a reference static image 90 based on reference static image data memorized in the ROM is projected by the first projector 10 on the screen surface. Then, the reference static image 90 is captured by the 3D camera 40, and the controller 50 receives the obtained image information therefrom. Based on the image information and the image projection area 61, a first positional correction amount, a first size correction amount and a first trapezoidal distortion correction amount are determined.

Specifically, a deviation amount between an origin P1 which is the left upper end of the reference static image 90 and a first origin Pa of the image projection area 61 in a x-y coordinates (x=coordinate in a crosswise direction; y=coordinate in a vertical direction) on the screen surface is determined first. Based on the deviation amount, the first positional correction amount is determined to transfer the origin P1 to the first origin Pa. In addition, based on a difference between a length L1 of the left side of the reference static image 90 and a vertical length La of the image projection area 61, the first size correction amount is determined for the length L1 to be the same as the vertical length La. Further, based on a difference between the length L1 of the left side of the reference static image 90 and a length L2 of the right side thereof, the first trapezoidal distortion correction amount is determined for the length L2 to be the same as the length L1. The three correction amount data are memorized in a flash memory.

Next, based on the first positional correction amount, the first size correction amount and the first trapezoidal distortion correction amount, the controller 50 corrects the original reference static image data, and outputs the corrected reference static image data to the first projector 10. Thus, the reference static image 90 after corrected is projected by the first projector 10 onto the screen surface. Then, in the same way, the first positional correction amount, the first size correction amount and the first trapezoidal distortion correction amount are determined. As shown in FIG. 4, when the reference static image 90 after corrected is projected at a desired position, and in a desired size and a desired shape. The three correction amounts are all less than predetermined thresholds. In this case, the controller 50 finishes correcting projection conditions of the first projector 10, and starts correcting projection conditions of the second projector 20. When any one of the correction amounts is greater than a specified threshold, the first positional correction amount, the first size correction amount and the first trapezoidal distortion correction amount determined just before renew the first positional correction amount, the first size correction amount and the first trapezoidal distortion correction amount in the flash memory. Then, based on the renewed first positional correction amount, first size correction amount and first trapezoidal distortion correction amount, the original reference static image data are corrected and the corrected reference static image data are output to the first projector 10. Hereafter, the same procedures are repeated until any of a first positional correction amount, a first size correction amount and a first trapezoidal distortion correction amount to be newly determined are less than thresholds.

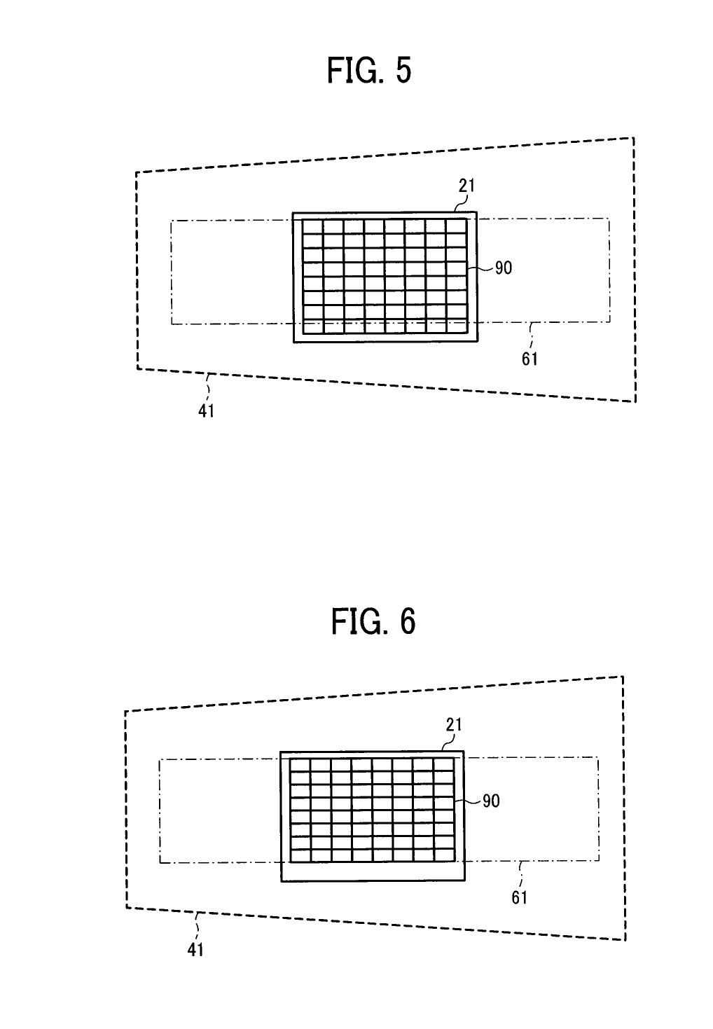

When the controller 50 starts correcting projection conditions of the second projector 20, as shown in FIG. 5, based on the reference static image data memorized in ROM, the controller 50 makes the second projector 20 project the original reference static image 90 onto the screen surface. Then, the controller 50 makes the 3D camera 40 image the reference static image 90 and receives image information obtained by the capturing from the 3D camera 40. Based on the image information and the image projection area 61, a second positional correction amount, a second size correction amount and a second trapezoidal distortion correction amount are determined in the same way using the first projector 10. The second positional correction amount is determined on the basis of a deviation amount between the origin P1 of the reference static image 90 and an unillustrated second origin set at specified position on the upper side of the image projection area 61 in a crosswise direction. In the same way using the first projector 10, determinations and renewals of the second positional correction amount, the second size correction amount and the second trapezoidal distortion correction amount are repeated until any of them are less than thresholds. Thus, as shown in FIG. 6, the reference static image 90 after corrected is projected at a desired position, and in a desired size and a desired shape in the second light spot.

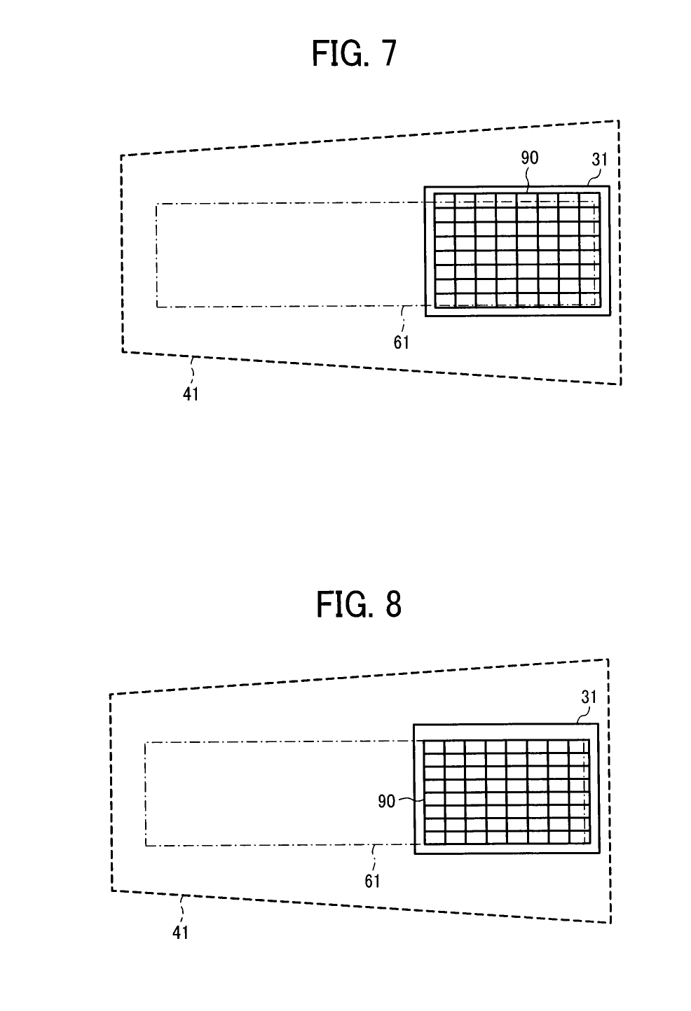

Then, the controller 50 starts correcting projection conditions of the second projector 30. As shown in FIG. 7, based on the reference static image data memorized in ROM, the controller 50 makes the second projector 30 project the original reference static image 90 onto the screen surface. Then, the controller 50 makes the 3D camera 40 image the reference static image 90 and receives image information obtained by the capturing from the 3D camera 40. Based on the image information and the image projection area 61, a third positional correction amount, a third size correction amount and a third trapezoidal distortion correction amount are determined in the same way using the first projector 10. The third positional correction amount is determined on the basis of a deviation amount between the origin P1 of the reference static image 90 and an unillustrated third origin set at specified position on the upper side of the image projection area 61 in a crosswise direction. In the same way using the first projector 10, determinations and renewals of the third positional correction amount, the third size correction amount and the third trapezoidal distortion correction amount are repeated until any of them are less than thresholds. Thus, as shown in FIG. 8, the reference static image 90 after corrected is projected at a desired position, and in a desired size and a desired shape in the third light spot 31.

The controller 50 having finished the projection condition correction process executes reproduction process when ordered by a user to reproduce the moving image. In the reproduction process, at first, based on the moving image data memorized in the hard disc, first partial moving image data which are cut from the left end on the moving image are constructed. In addition, second partial moving image data which are cut from the center on the moving image and third partial moving image data which are cut from the eight end on the moving image are constructed.

Then, based on the first positional correction amount, the first size correction amount and the first trapezoidal distortion correction amount memorized in the flash memory, the first partial moving image data are corrected. In addition, based on the second positional correction amount, the second size correction amount and the second trapezoidal distortion correction amount memorized in the flash memory, the second partial moving image data are corrected. Further, based on the third positional correction amount, the third size correction amount and the third trapezoidal distortion correction amount memorized in the flash memory, the third partial moving image data are corrected. Then, in a predetermined timing, transfer of the corrected first partial moving image data to the first projector 10 is started. At the same time, transfer of the corrected second partial moving image data to the second projector 20 and transfer of the corrected third partial moving image data to the third projector 30 are started. Thus, the three partial moving images are combined to project the original moving image onto the screen 1.

An example of correcting image information of a moving image to correct a position, a size and a trapezoidal distortion of a projection image has been explained. They may be corrected by physical means. For example, the projectors are configured to be capable of moving the projection lenses in a direction perpendicular to light axes, and the projectors may move the project lenses to positions in accordance with the positional correction amounts to correct the position of the projection image. In addition, the projectors are configured to be capable of changing projection magnifications, and the projectors may adjust the projection magnifications in accordance with the size correction amounts to correct the size of the projection image. Further, the projectors are configured to be capable of automatically correcting slopes, and the projectors may automatically correct the slopes in accordance with the trapezoidal distortion amounts to correct the trapezoidal distortion of the projection image.

Next, a specific configuration in the embodiment of the image projection system of the present invention is explained.

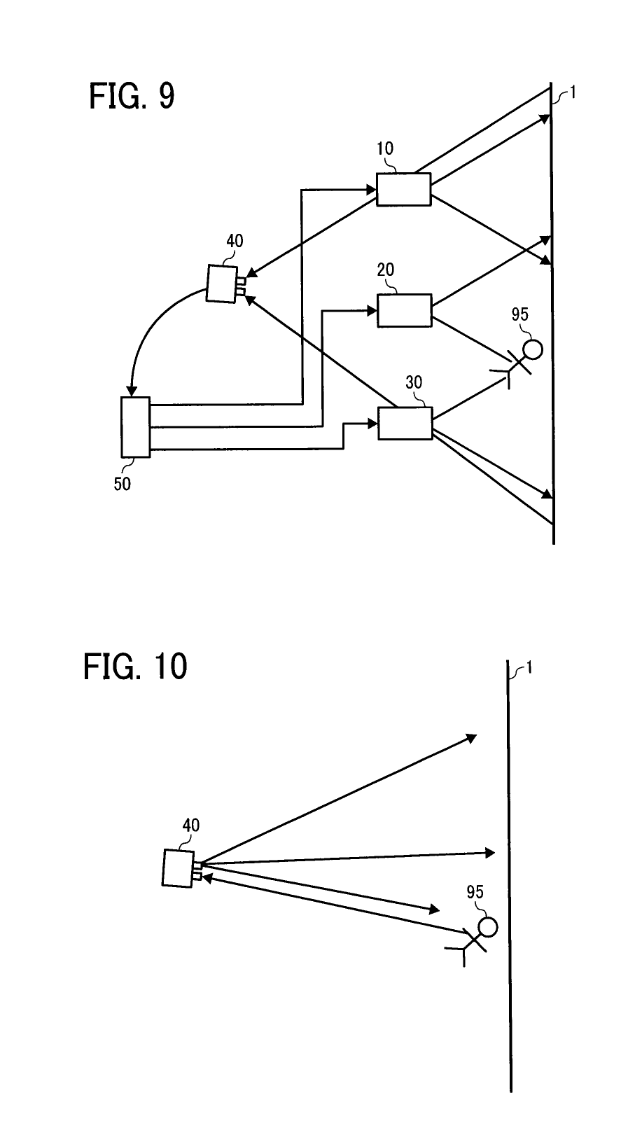

FIG. 9 is a schematic plain view illustrating the image projection system with a spectator 95 as an intervening member. As FIG. 9 shows, the spectator 95 as an intervening member is occasionally lies between at least one of the three projectors and the screen 1. In FIG. 9, the spectator 95 stands at a position where a part of the second partial moving image projected by the projector 20 and a part of the third partial moving image projected by the projector 30 are projected on the surface of the spectator.

The above projection condition correction process was explained, assuming an intervening member such as a spectator 95 does not lie between at least one of the three projectors and the screen 1. The controller 50 executes a process different from the above when a part of the reference static image 90 is projected on the surface of the intervening member such as a spectator.

In this image projection system, a combination of the 3D camera 40 and the controller 50 lie between the projector and the screen surface and works as an intervening member detector detecting an intervening member a part of the reference static image is projected on. The controller 50 detects a shape of the intervening member and a position thereof in the screen surface direction besides existence thereof

FIG. 10 is a schematic plain view for explaining TOF method which is one of methods of measuring distances using the 3D camera 40. In FIG. 10, the spectator 95 as an intervening member is present between the 3D camera 40 and the screen 1. The 3D camera 40, a light source (typically infrared) widely emitting light in the direction of an object to image, and a photodetector receiving light reflected from the object are located. A time from emitting light to receiving light reflected from the object to image such as the spectator 95 with the photodetector for each pixel is determined. Based on the time, a distance between the 3D camera 40 and the object is determined. The controller 50 executes the operation on all areas in the light spots 11, 21 and 31 projecting the reference static image 90. The resultant distances are the same because light reflected from the screen surface is received for most pixels (screen distance). However, pixels receiving light reflected from the spectator 95 has a shorter distance than the screen distance. The controller 50 detects existence of the spectator 95 as an intervening member when the number of pixels having shorter distances than the screen distance (short distance pixel) exceeds a threshold. Further, based on plural short distance pixels, a shape of the spectator 95 and a position thereof in the screen surface direction.

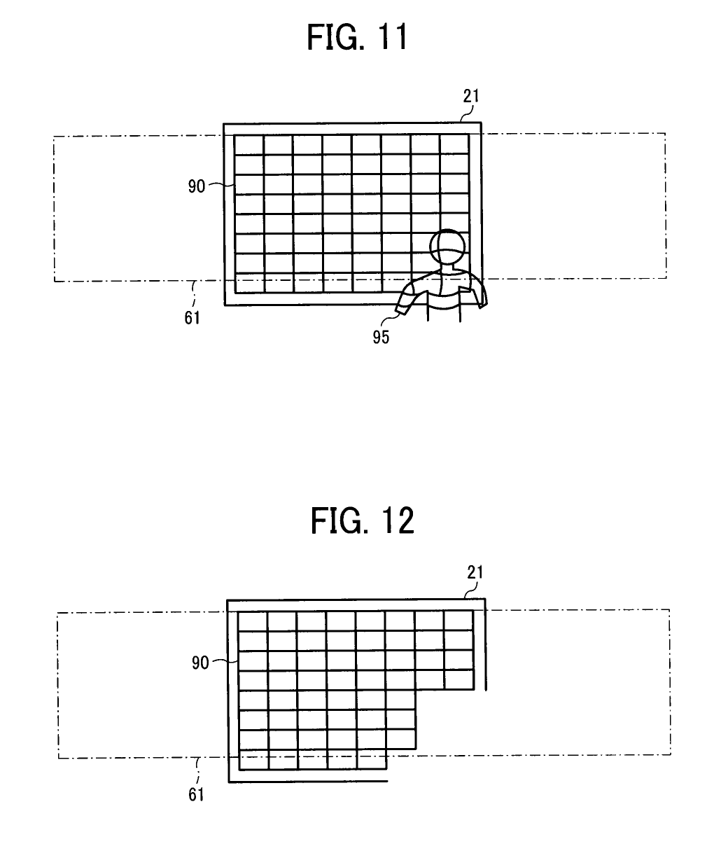

FIG. 11 is a front view illustrating the reference static image 90 projected on a screen by the second projector 20 in correction process of projection conditions. As illustrated, the right bottom part of the reference static image 90 is projected on the surface of the spectator 95, not on the screen surface, and the reference static image 90 has a distorted lattice shape. Because of this, the reference static image 90 has a shorter right side (L2 in FIG. 3) than the original. The positional correction amount and the size correction amount are determined on the basis of a lattice at the left side end of the reference static image 90 as mentioned above, and the lattice is correctly projected on the screen surface. Therefore, the positional correction amount and the size correction amount are properly determined. However, since the trapezoidal distortion correction amount is determined on the basis of a length of the right side of the reference static image 90, which is shorter than the original, it is not properly determined.

Then, detecting the shape and the position of the spectator 95, the controller 50 recognizes an area projected on the spectator 95 of all areas of the reference static image 90 based on the detection result as mentioned above. As shown in FIG. 12, of all the areas of the reference static image 90, the image information thereof obtained by capturing is corrected so as to leave only the image part except for the above area. Then, based on the corrected reference static image 90, the positional correction amount, the size correction amount and the trapezoidal distortion correction amount are determined. When the trapezoidal distortion correction amount is determined, a length of the right side cannot be determined as it is because almost lower half thereof disappears. Then, from the right end to the left end of the reference static image 90, existence of a vertical line normally extending from the upper end to the bottom end of the lattice is detected. In FIG. 12, the fourth vertical line from the right side is detected. The controller 50 determines an estimated value of the right side on the basis of a length of the fourth vertical line in vertical direction, a distance between the vertical line and the right side and a distance between the vertical line and the left side. Then, based on the length of the left side and the estimated value, the trapezoidal distortion correction amount is determined. Thus, unsuitability of the trapezoidal distortion correction amount caused by intervention of the spectator 95 is prevented to prevent a projection image from deteriorating in quality.

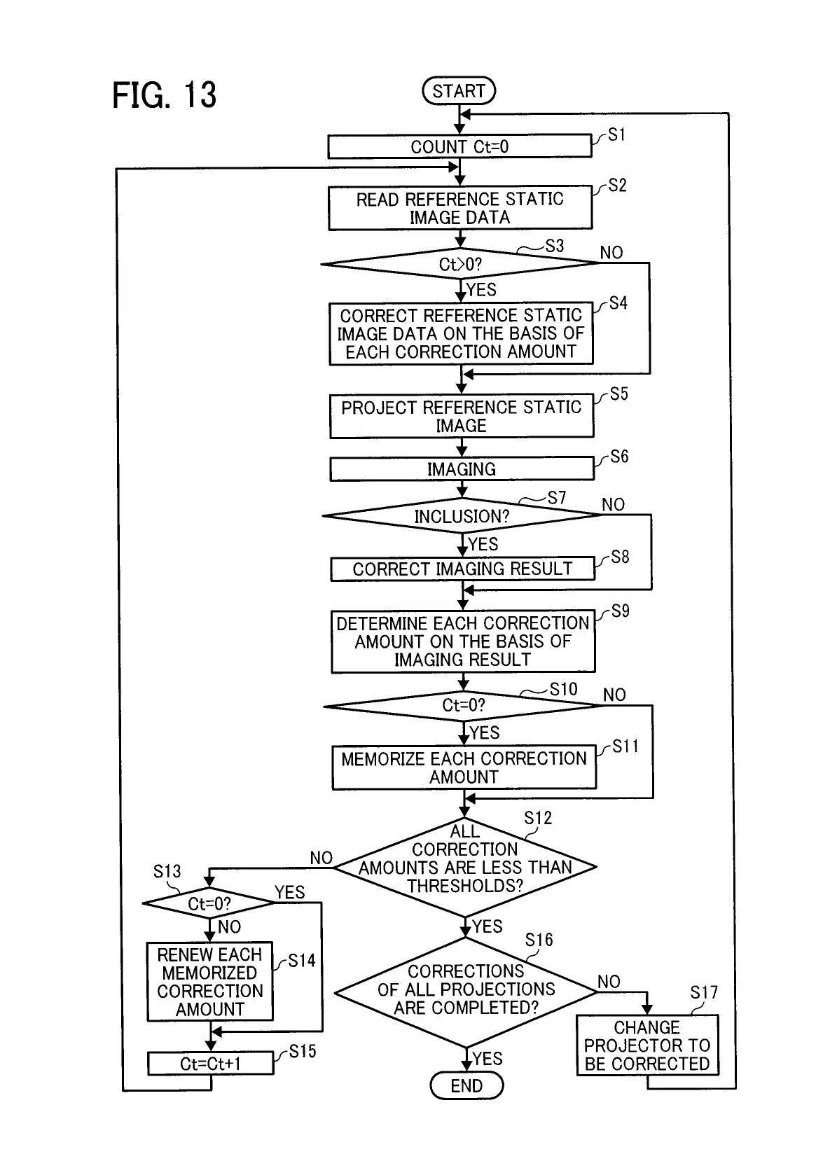

FIG. 13 is a flowchart showing correction process of projection conditions executed by the controller 50 in the image projection system. First, after resetting a count value Ct (STEP 1: S1) to zero, the controller 50 reads reference static image data (S2). Then, whether the count value Ct exceeds zero is determined (S3). When the count value Ct exceeds zero (Y at S3), due to a loop of process flow from S14 mentioned later, suitability of each of the positional correction amount, the size correction amount and the trapezoidal distortion correction amount needs judging. Then, the controller 50 reads the data of the positional correction amount, the size correction amount and the trapezoidal distortion correction amount memorized in the flash memory, and corrects the reference static image data on the basis of the correction amounts (S4). When the count value Ct does not exceed zero (N at S3), the positional correction amount, the size correction amount and the trapezoidal distortion correction amount are not yet needed. The controller 50 omits the S4 process of correcting the reference static image data, and proceeds the process flow to S5.

In S5, the controller 50 makes the projector(s) the projection conditions of which to be corrected of the three projectors project the reference static image 90 based on the reference static image data. Then, after the 3D camera 40 images (S6), based on image information obtained by the capturing, existence of an intervening member such as the spectator 95 is detected. When an intervening member exists (Y at S7), after the capturing result is corrected on the basis of a shape and a position of the intervening member (S8), the process flow is proceeded to S9 mentioned later. When an intervening member does not exist (N at S7), S8 is omitted and the process flow is proceeded to S9 mentioned later.

In S9, based on the capturing result, the controller 50 determines the positional correction amount, the size correction amount and the trapezoidal distortion correction amount. Then, whether the count value Ct is zero is judged (S10). When the count value Ct is zero (Y at S10), the positional correction amount, the size correction amount and the trapezoidal distortion correction amount are not yet memorized in the flash memory. Then, the controller 50 memorizes the correction amounts in the flash memory (S11) and proceeds the process flow to S12 mentioned later. When the count value Ct is not zero (N at S10), the controller 50 omits S11 and proceeds the process flow to S12 mentioned later.

In S12, the controller 50 judges all the positional correction amount, the size correction amount and the trapezoidal distortion correction amount determined in S9 are less than specified thresholds (S12). When one or more of the correction amounts are less than the thresholds (N at S12), any one of the position, size and trapezoidal distortion corrections is incomplete. Then, the controller 50 loops the process flow to S2 through S13 to S15 to renew the positional correction amount, the size correction amount and the trapezoidal distortion correction amount memorized in the flash memory. When all the correction amounts are less than the thresholds (Y at S12), all the position, size and trapezoidal distortion corrections are properly made. Then, the controller 50 proceeds the process flow to S16 mentioned later.

In S13, the controller 50 judges whether the count value is zero. When the count value is not zero (N at S13), after each of the correction amounts determined in S9 was added to renew the positional correction amount, the size correction amount and the trapezoidal distortion correction amount memorized in the flash memory, suitability of each of the renewed correction amounts needs judging. Then, the controller 50 counts up only one count value Ct after the renewal (S15). Then, the flow process is proceeded to S2 to judge suitability of the correction amounts after renewed. When the count value is zero (Y at S13), the controller 50 omits S14 and proceeds the process flow to S15 and S2 because data for renewing the correction amounts memorized in the flash memory do not exist.

When all the position, size and trapezoidal distortion corrections are properly made, all the correction amounts are judged to be less than the thresholds. Then, the controller 50 proceeds the process flow to S16.

In S16, the controller 50 judges whether the corrections of all the projectors are completed. When not completed (N at S16), after the projector to be corrected is changed (S17), the process flow is looped to S1. Thus, correction of projection conditions for the projector after changed starts. When corrections of all the projectors are completed (Y at S16), a series of the process flow is completed.

Another embodiment of the image projection system of the present invention is explained. The above-mentioned embodiment is partially modified to form this another embodiment, and the configurations thereof are the same as those of the above-mentioned embodiment unless otherwise specified.

FIG. 14 is a schematic plain view illustrating a main configuration of another embodiment of the image projection system of the present invention. As capturing means, a first camera 41 and a second camera 42 are located instead of the 3D camera to image a screen surface in directions different from each other.

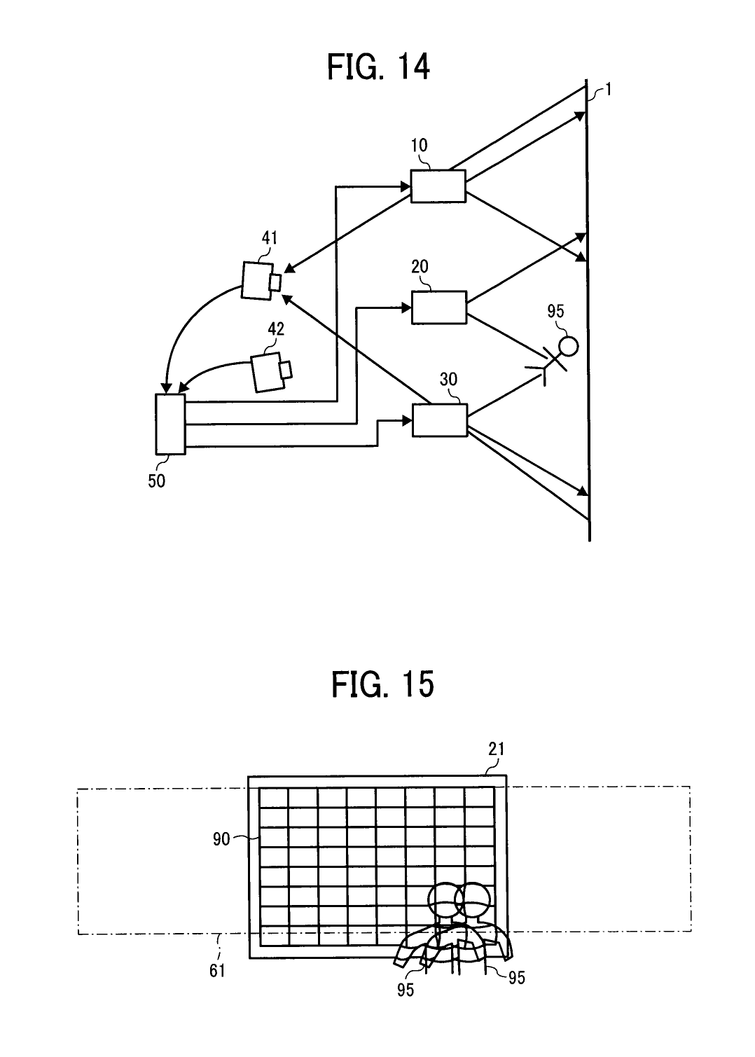

A controller 50 subjects each of images captured by the first camera 41 and the second camera 42 to keystone correction to modify them into a rectangle, and overlaps the images so as to have the highest concordance. Then, the synthesized image is like an image shown in FIG. 15. A spectator 95 present before the screen surface as an intervening member is doubly projected due to parallax. The controller 50 judges an intervening member exists in an area where it is doubly projected. Then, image data obtained by the capturing are corrected to exclude the area.

The first camera 41 and the second camera 42 may be combined to form a 3D camera to make the same corrections in the above-mentioned embodiment.

Having now fully described the invention, it will be apparent to one of ordinary skill in the art that many changes and modifications can be made thereto without departing from the spirit and scope of the invention as set forth therein.

What is claimed is:

1. An image projection system, comprising:
an image projection means configured to project an image on a projection surface to form a reference image thereon;
an capturing means configured to capture the reference image to obtain an capturing result;
a projection conditions correction means configured to correct projection conditions of the image projection mean on the basis of the capturing result;
an intervening member detection means configured to detect an intervening member lying between the image projection means and the projection surface to obtain a detection result; and
an capturing result correction means configured to correct the capturing result on the basis of the detection result,
wherein the projection conditions correction means corrects the projection conditions on the basis of the capturing result corrected by the capturing result correction means when the intervening member is detected by the intervening member detection means.

2. The image projection system of claim 1, wherein the intervening member detection means detects existence of the intervening member, a shape thereof and a position thereof in a projection surface direction, and the projection conditions correction means recognizes an area projected on the intervening member out of the entire areas of the reference image captured by the capturing means and corrects the projection conditions on the basis of the reference image except for the area projected on the intervening member when the intervening member is detected by the intervening member detection means.

3. The image projection system of claim 2, wherein the capturing means is a three dimensional (3D) camera, and the intervening member detection means recognizes distance information among each part of the reference image and the 3D camera on the basis of the capturing result of the reference image and detects the existence of the intervening member, the shape thereof and the position thereof in the projection surface direction on the basis of the recognize result.

4. The image projection system of claim 2, wherein the capturing means includes a plurality of cameras capturing the projection surface in directions different from each other, and the intervening member detection means detects the existence of the intervening member, the shape thereof and the position thereof in the projection surface direction on the basis of each of capturing results of the plural cameras.

5. The image projection system of claim 1, wherein the capturing means comprises a plurality of cameras capturing the projection surface in directions different from each other, and the intervening member detection means recognizes parallax information of the plurality of cameras for each part of the reference image and detects the existence of the intervening member.

6. The image projection system of claim 1, wherein the projection conditions correction means corrects a position of a projection image on the projection surface.

7. The image projection system of claim 1, wherein the projection conditions correction means corrects a size of a projection image on the projection surface.

8. The image projection system of claim 1, wherein the projection conditions correction means corrects a trapezoidal distortion correction amount.

9. The image projection system of claim 1, further comprising a plurality of image projection means configured to individually project their partial images onto areas different from each other on the projection surface and combine the partial images to form a combined image, and the projection conditions correction means individually corrects each of the projection conditions of the plurality of image projection means on the basis of the capturing result of the capturing means.
